(19) United States
(12) Patent Application Publication
(10) Pub. No.: US 2026/0015097 A1
(43) Pub. Date: Jan. 15, 2026

(54) PROPULSION UNIT FOR AIRCRAFT

(71) Applicant: SAFRAN ELECTRICAL & POWER, BLAGNAC CEDEX (FR)

(72) Inventors: Vincent CHAPERON, MOISSY-CRAMAYEL (FR); Samir NEHME, MOISSY-CRAMAYEL (FR); Abdoulahad THIAM, MOISSY-CRAMAYEL (FR)

(21) Appl. No.: 18/881,020

(22) PCT Filed: Jun. 29, 2023
(86) PCT No.: PCT/FR2023/050995

§ 371 Date: Jan. 3, 2025

(30) Foreign Application Priority Data
Jul. 7, 2022 (FR) FR2206938

(51) Int. Cl. B64D 33/08; B64D 27/35

(52) U.S. Cl. CPC B64D 33/08; B64D 27/35

(57) ABSTRACT

An aircraft propulsion unit with an electrical motor that includes an annular stator around a longitudinal axis and a rotor arranged radially inside the stator, in order to be rotated around the longitudinal axis. An electric-power module supplies the electric motor with electricity, where the electric-power module includes an annular housing which extends along the longitudinal axis, and where the housing of the electric-power module includes a first end arranged longitudinally opposite a first end of the stator of the electric motor. The electric motor and the electric-power module are cooled with a heatsink inserted longitudinally between the first end of the stator of the electric motor and the first end of the housing of the electric-power module.

### FIELD OF THE INVENTION

The present description relates to a propulsion unit for aircraft. Specifically, the present description relates to a propulsion unit for aircraft with electric or hybrid propulsion.

### Description of Related Art

The objectives for limitation of carbon emissions in the aeronautic industry are pushing industrial companies to turn to electric or hybrid propulsion systems (hybrid meaning comprising both a thermal propulsion system and an electrical propulsion system).

As is well known, an electrical propulsion unit such as shown in FIG. 1 comprises an electric motor 10 and an electric-power module 20. In order to make the electrical propulsion unit compact and to limit the cabling length, the electric-power module 20 is directly related to the electrical motor 10.

The electric motor 10 is generally a permanent-magnet synchronous motor. For this purpose, the electric motor 10 comprises an annular stator 10 and a rotor arranged inside the stator 10. The rotor comprises a shaft 12 which extends along a longitudinal axis X.

The electric-power module 20 comprises an annular housing 21 which defines a passage along the longitudinal direction and through which the shaft 12 of the rotor passes. With the electric-power module 20, the DC voltage can be converted into an AC voltage, in particular three-phase, to power the electric motor 10. The DC voltage is delivered by a DC voltage source such as an electric battery. To allow the electric conversion, the electric-power module 20 comprises a plurality of three-phase inverters mounted annularly on the housing 21 so as to be directly electrically linked to the stator 10. The electric-power module 20 may further comprise three power modules per inverter, i.e. one for each inverter output, to power the stator 10 and rotate the shaft 12 of the rotor around the longitudinal axis X.

Because the electric motor 10 and the electric-power module 20 form a single assembly, the electric-power module 20 is installed in an unfavorable vibrational and thermal environment. To limit the risk of failures and malfunction, a solution with redundancy is then provided. For this purpose, the electric-power module 20 comprises two parallel power channels which can operate individually or collectively. The result of this is that the electric-power module 20 comprises a large number of power modules, which generates an even greater amount of heat.

To avoid failures and keep optimal performance, the electrical propulsion unit and in particular the electric-power module 20 then needs to be cooled. To do that, it is known to arrange a cooling circuit on or in the wall of the housing 21 of the electric-power module 20 and to feed it with a cooling fluid with which the power modules can be cooled.

The cooling provided by such a cooling system is however limited. Further, increasing its performance goes against objectives of reducing the bulk and mass. The cooling system further has the disadvantage of being susceptible to leaks and requires external mechanical elements for assuring operation thereof (pump for circulation of the fluid in the conduit, for example).

### BRIEF SUMMARY OF THE INVENTION

An aircraft propulsion unit is proposed, the propulsion unit comprising:
an electrical motor which comprises an annular stator around a longitudinal axis and a rotor arranged, at least in part, radially inside the stator, in order to be rotated around the longitudinal axis;
an electric-power module suited for supplying the electric motor with electricity, where the electric-power module comprises an annular housing which extends along the longitudinal axis, and where the housing of the electric-power module comprises a first end arranged longitudinally opposite a first end of the stator of the electric motor;
means for cooling the electric motor and the electric-power module, where the cooling means comprise a heatsink inserted longitudinally between the first end of the stator of the electric motor and the first end of the housing of the electric-power module.

The heatsink serves to evacuate heat generated by the electric motor and the electric-power module to the ambient air surrounding the motor and the electric-power module. The heatsink also serves to evacuate the heat passively. In this sense, the heatsink may be described as passive. In fact, the heat generated by the motor and the electric-power module is transmitted to the heatsink by thermal conduction because of the contact between the heatsink and both the motor and the electric-power module. The heat is then evacuated by convection with the ambient air. In that way, the heatsink is distinguished from active heat exchangers which comprise a working fluid circulating in the hermetic conduit and for which the heat is evacuated by means of the working fluid.

Thus, the heatsink has the advantage of not needing an external mechanical element for operation thereof and advantageously does not have a risk of leaks. Such a heatsink is therefore more reliable.

The heatsink may be supported along the longitudinal axis by both the first end of the stator of the electric motor and also on the first end of the housing of the electric-power module. The heatsink may be supported on the first end of the stator of the electric motor along a first orientation of the longitudinal direction and on the first end of the housing of the electric-power module along a second orientation of the longitudinal direction. The heatsink may comprise at least one first surface bearing on the first end of the stator of the electric motor and at least one second surface, longitudinally opposite the first surface, bearing on the first end of the housing of the electric-power module.

The heatsink may comprise a radially outer surface without any contact with a solid conducting element, in particular the stator of the motor and/or the housing of the electric-power module. The radially outer surface of the heatsink may be configured to allow heat transfer with the ambient air outside the motor and the electric-power module.

The stator of the electric motor and the housing of the electric-power module may have a section perpendicular to the longitudinal axis that has the same shape and the same dimensions. The stator of the electric motor may be a cylinder with circular section extending along the longitudinal axis. The housing of the electric-power module may be a cylinder with circular section extending along the longitudinal axis. The circular section of the stator may have the same diameter as the circular section of the housing of the electric-power module.

The housing of the electric-power module and the stator of the electric motor may be joined to each other near their first end. The first ends of the stator and the housing may be considered in the longitudinal direction. The housing may be connected to the stator of the electric motor, for example by bolted connections.

The heatsink may comprise a disk which extends perpendicularly to the longitudinal axis, where the disk comprises at least one first surface bearing on the first end of the stator of the electric motor and at least one second surface, longitudinally opposite the first surface, bearing on the first end of the housing of the electric-power module.

The disk of the sink, because of the circular shape thereof, allows a homogeneous evacuation of the heat around the longitudinal axis. The disk may have the same diameter as the circular section of the stator of the motor and of the housing of the electric-power module. The radially outer surface of the sink may be a cylinder of revolution around the longitudinal axis.

The heatsink may comprise at least one fin extending radially outward from the periphery of the disk, where the heatsink preferably comprises a plurality of fins uniformly distributed around the longitudinal axis, and where the fins of the heatsink are again preferably arranged in groups of at least two fins. Also, said at least one fin may extend radially outward from the radially outer surface of the disk. The fins serve to increase the surface for thermal exchange by convection between the disk and the ambient air, thus improving the performance of the heatsink.

The heatsink may be made of a material suited for dissipating heat. The heatsink may be made of a metal, specifically aluminum or copper.

The rotor may comprise a shaft extending along the longitudinal axis, where the shaft continues radially inside the housing of the electric-power module, and where the heatsink comprises an opening through which the shaft of the rotor extends. The shaft may project from a longitudinal end of the housing of the electric-power module which is opposite the electric motor. The shaft may drive a propeller of the propulsion unit, possibly through a transmission.

The cooling means may comprise at least one annular row of blades secured to the shaft of the rotor, where the annular row of blades is arranged radially inside the housing, and where the annular row of blades is shaped for propelling an airflow over the heatsink when it is rotated around the longitudinal axis by means of the shaft.

The airflow blown on the heatsink serves to improve the evacuation of the heat accumulated in the heatsink by forced convection. The cooling of the heatsink and therefore of the electric motor and the electric-power module is improved. Further, the driving of the blades is implemented by the rotation of the shaft of the rotor and therefore does not need any additional mechanical element. That serves to minimize the energy consumption needed to cool the electric motor and the electric-power module, and that also serves to reduce possible sources of failure.

The housing may comprise an end wall which extends transversely, preferably perpendicularly, to the longitudinal axis near a second end of the housing in the longitudinal direction, where the housing comprises at least one inlet opening formed through the end wall to provide a passage for the airflow from the outside of the housing to the inside of the housing. The housing may for example comprise four inlet openings. The inlet openings may be uniformly distributed around the longitudinal axis. The second end of the housing may be opposite the first end of the housing.

The housing may comprise at least one outlet opening near the first end to provide a passage for the airflow from inside the housing to outside the housing. The housing may comprise a cylindrical wall extending along the longitudinal axis. Each outlet opening may be formed through the cylindrical wall. The housing may for example comprise six outlet openings. The outlet openings may be uniformly distributed around the longitudinal axis. Each outlet opening may be formed through the cylindrical wall near a longitudinal end of the housing which is opposite the heatsink.

The cooling means may comprise at least one cooling circuit arranged on the periphery of the stator of the motor and/or on the periphery of the housing of the electric-power module. A cooling fluid may circulate to produce an exchange of heat with, as applicable, the stator of the motor and/or the housing of the electric-power module. The cooling fluid may be oil or any other suitable heat-transfer fluid. The cooling means comprising the combination of the heatsink and said at least one cooling circuit allow an increased cooling of the stator of the electric motor and the housing of the electric-power module without increasing the bulk of the propulsion unit. Further, the presence of two distinct members participating in the cooling allows a redundancy of the cooling means. In other words, cooling of the electric motor or electric-power module may be done even in case of failure of the cooling circuit or heatsink.

The cooling means may comprise a cooling circuit arranged on the periphery of the stator of the electric motor and a cooling circuit arranged on the periphery of the housing of the electric-power module. Each cooling circuit may comprise at least one inlet nozzle and one outlet nozzle for the cooling fluid. Each cooling circuit may be formed entirely in one wall of the stator and/or the housing.

The electric motor may comprise N input connectors with N>1. Each input connector may be arranged on a radially outer surface of the stator, near the first longitudinal end of the stator. The input connectors may be uniformly distributed around the longitudinal axis.

The electric-power module may comprise N output connectors. Each output connector may be arranged on a radially outer surface of the housing, near the first longitudinal end of the housing. The output connectors may be uniformly distributed around the longitudinal axis. Each output connector of the electric-power module may be electrically linked, i.e. connected, to an input connector of the electric motor. Each output connector may be arranged longitudinally opposite an input connector of the motor in order to be electrically linked thereto. Each assembly formed of an input connector and an output connector linked to each other forms an electrical link between the electric motor and the electric-power module. Each input connector and each output connector may be protected by a cover.

According to a preferred embodiment, N is equal to 6. Two circumferentially consecutive output connectors may be separated from each other by a 60° angle around the longitudinal axis. Two circumferentially consecutive input connectors may be separated from each other by a 60° angle around the longitudinal axis. The heatsink may comprise N groups of fins. The fins from each group may be arranged circumferentially between two circumferentially consecutive electrical links.

Each outlet opening of the housing of the electric-power module may be circumferentially arranged between two circumferentially consecutive output connectors.

The electric motor may be a permanent-magnet synchronous motor. The motor may be a star-mounted three-phase motor. Each input connector and each output connector may be three-phase. The electric-power module may comprise N inverters and a plurality of power modules. Each inverter may be linked to three power modules each of which is linked to one output phase of one of the output connectors of the electric-power module. Each inverter and each power module are mounted on the housing of the electric-power module, in particular on a radially inner surface or on a radially outer surface of the housing. The inverters may be uniformly distributed around the longitudinal axis. Similarly, the power modules may be uniformly distributed around the longitudinal axis. The power modules may be arranged circumferentially, alternating on the radially inner surface and the radially outer surface of the housing. Each inverter serves to convert a DC voltage provided by a DC voltage source such as a battery into an alternating current. The electric-power module may allow the distribution of power included between 400 kW and 1 MW.

According to another aspect, an aircraft is proposed comprising at least one propulsion unit such as described above.

### BRIEF DESCRIPTION OF THE DRAWINGS

Other characteristics, details and advantages will appear upon reading the following detailed description, and analyzing the attached drawings, on which:

FIG. 1 shows a perspective view of an assembly for electric propulsion according to the state-of-the-art;

FIG. 2 shows a schematic view in longitudinal section of an assembly for electric propulsion according to the present description;

FIG. 3 shows an exploded view in perspective of the assembly from FIG. 2;

FIG. 4 shows an exploded, schematic view in section of the assembly from FIG. 2;

FIG. 5 shows a schematic view in section of an electric-power module from the assembly in FIG. 2 in the section plane V-V;

FIG. 6 shows a frontal schematic view of a heatsink from the assembly from FIG. 2.

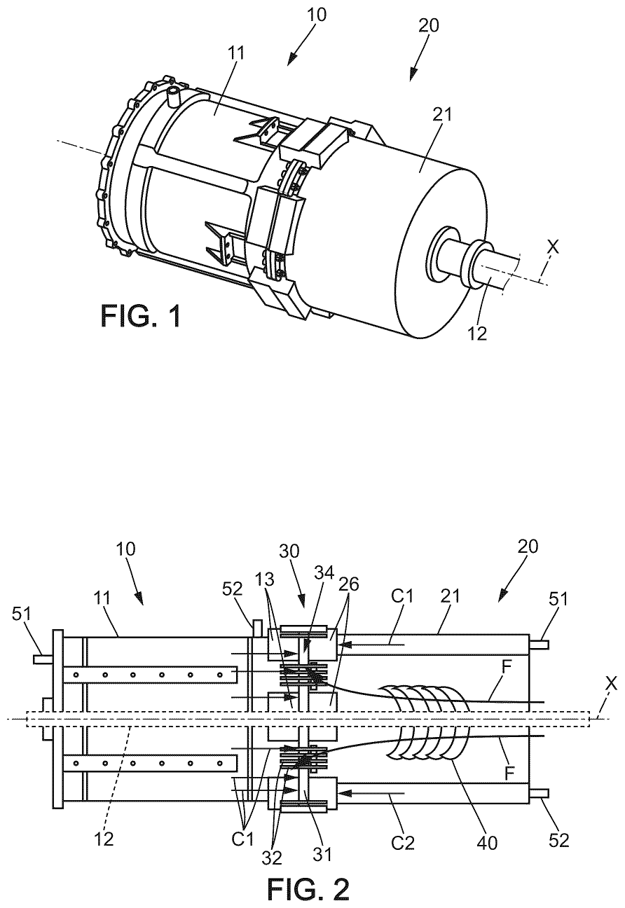

### DETAILED DESCRIPTION OF THE INVENTION

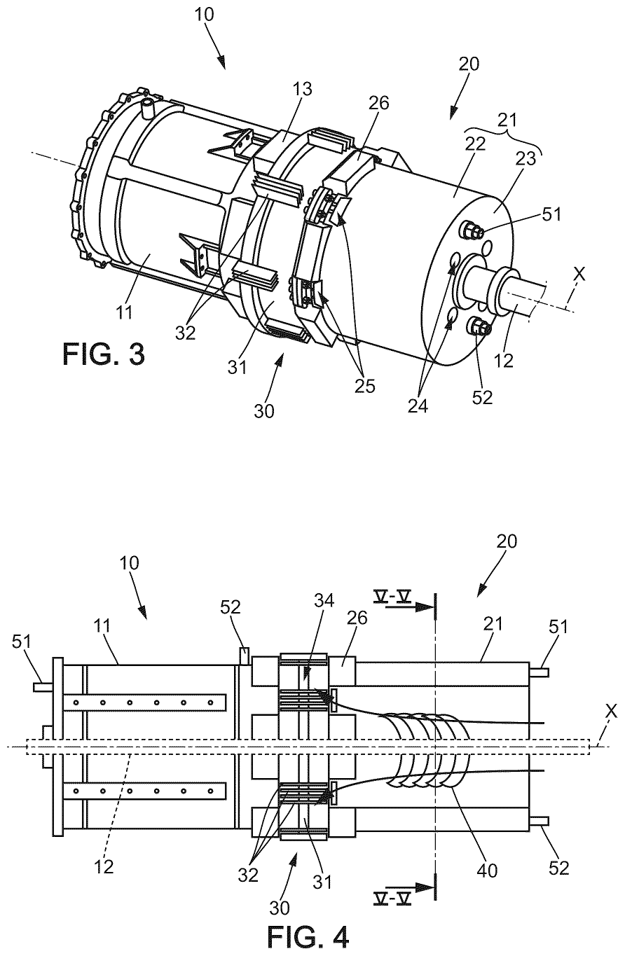

Now referring to FIGS. 2 to 6. FIGS. 2 to 4 show a propulsion unit for an aircraft with electric or hybrid propulsion. The propulsion unit comprises an electric motor 10, an electric-power module 20 and cooling means for the electric motor 10 and the electric-power module 20.

The electric motor 10 may be a permanent-magnet synchronous motor. The electric motor 10 may be a star-mounted three-phase motor. The motor comprises an annular stator 11 around a longitudinal axis X and a rotor arranged, here in part, radially inside the stator 11, in order to be rotated around the longitudinal axis X. The rotor comprises a shaft 12 which extends along the longitudinal axis X. The shaft 12 may drive a propeller of the propulsion unit, possibly through a transmission.

In the present disclosure, the longitudinal direction corresponds to the direction of the longitudinal axis X. The longitudinal axis X coincides with an axis of rotation of the rotary parts of the propulsion unit. The orientation qualifiers, such as “longitudinal,” “radial” or “circumferential” are defined with reference to the longitudinal axis. The radial direction as a direction perpendicular to the longitudinal axis X. At a point away from the longitudinal axis, a circumferential direction corresponds to a direction perpendicular to the axial and radial directions.

Further, unless otherwise indicated, the adjectives “inside,” “inner,” “outside” and “outer” are used with reference to a radial direction such that the inside/inner part (i.e. radially inside/inner) of an element is closer to the longitudinal axis than the outside/outer (radially outside/outer) part of the same element.

The electric-power module 20 is suited for powering the electric motor 10 with electricity. The electric-power module 20 comprises an annular housing 21 which extends along the longitudinal axis X. The housing 12 is therefore hollow. In other words, the housing 21 defines a longitudinal passage. The housing 21 for the electric-power module 20 comprises a first end arranged longitudinally opposite a first end of the stator 11 of the electric motor 10. The first end of the stator 11 and the first end of the housing 21 are each considered in the longitudinal direction. The shaft 12 extends radially to the inside of the housing 21 of the electric-power module 21. Also, the shaft 12 projects from a second longitudinal end of the housing 21 of the electric-power module 20 which is opposite the electric motor 10. The second end of the housing 21 is longitudinally opposite the first end.

The housing 21 comprises a cylindrical wall 22 extending along the longitudinal axis X. The housing 21 also comprises an end wall 23 which extends perpendicularly to the longitudinal axis X near the second end of the housing 21 in the longitudinal direction. The first end and the second end of the housing 21 respectively coincide with a first end and a second end of the cylindrical wall 22 (also considered in the longitudinal direction). The end wall 23 of the housing 21 here comprises an orifice for passage of the shaft 12 of the rotor.

Remarkably, the stator 11 of the electric motor 10 and the housing 21 of the electric-power module 20 here have a section perpendicular to the longitudinal axis X that has the same shape and the same dimensions. The stator 11 of the electric motor 10 is a cylinder with circular section extending along the longitudinal axis X. The housing 21 of the electric-power module is also a cylinder with circular section extending along the longitudinal axis X. The circular section of the stator 11 has the same diameter as the circular section of the housing 21 of the electric-power module 20.

The housing 21 of the electric-power module 20 and the stator 11 of the electric motor 10 may be joined to each other near their respective first end. The housing 21 may be connected to the stator 11 of the electric motor 10, for example by bolted connections.

The electric motor 10 here comprises six input connectors 13. The electric-power module 20 comprises six output connectors 26. Each output connector 26 of the electric-power module 20 is thus electrically linked, i.e. connected, to an input connector 13 of the electric motor 10 to allow the electric supply of the electric motor 10 by the electric-power module 20. Each input connector 13 and each output connector 26 may be three-phase. Each assembly comprising an input connector 13 and an output connector 26 linked to each other therefore forms an electrical link between the electric motor 10 and the electric-power module 20. Each electrical link is here protected by a respective cover.

Each input connector 13 is arranged on a radially outer surface of the stator 11, near the first longitudinal end of the stator 11. Each output connector 26 is arranged on a radially outer surface of the housing 21, near the first longitudinal end of the housing 21. The output connectors 26 and the input connectors 13 are uniformly distributed around the longitudinal axis. Two circumferentially consecutive outputs 26, respectively input, connectors are therefore separated from each other by a 60° angle around the longitudinal axis X. Each output connector 26 is also arranged longitudinally opposite an input connector 13 of the motor in order to be electrically linked thereto. The length of cabling is thus minimized.

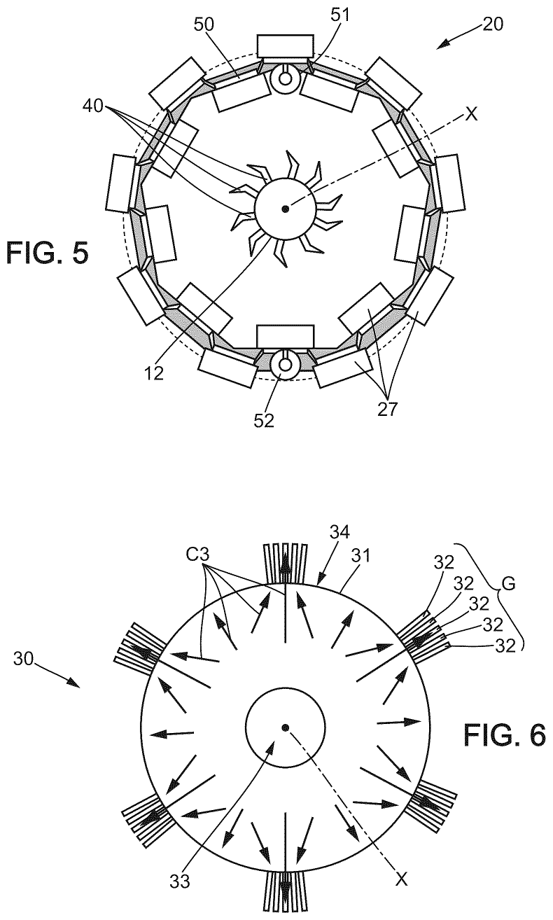

The electric-power module 20 also comprises six inverters and a plurality of power modules 27 where these latter are in particular visible in FIG. 5. Each inverter is linked to three power modules 27 each of which is linked to one output phase of one of the output connectors 26 of the electric-power module 20. The electric-power module 20 therefore here comprises 18 power modules 27. Each inverter and each power module 27 are mounted on the housing 21 of the electric-power module 20, in particular on a radially inner surface or on a radially outer surface of the housing 21. In particular, the power modules 27 are arranged circumferentially, alternating on the radially inner surface and the radially outer surface of the housing 21. The inverters and the power modules 27 may also be uniformly distributed around the longitudinal axis X. Each inverter serves to convert a DC voltage provided by a DC voltage source such as a battery into an alternating current. The electric-power module 20 may allow the distribution of the power included between 400 kW and 1 MW to the electric motor 10.

The cooling means first comprise a heatsink 30. The heatsink 30 is shown in isolation in FIG. 6.

The heatsink 30 is inserted longitudinally between the first end of the stator 11 of the electric motor 10 and the first end of the housing 21 of the electric-power module 20. The heatsink 30 is therefore supported on the first end of the stator 11 of the electric motor 10 along a first orientation of the longitudinal direction and on the first end of the housing 21 of the electric-power module 20 along a second orientation of the longitudinal direction. The heatsink 30 comprises for this purpose at least one first surface bearing on the first end of the stator 11 of the electric motor 10 and at least one second surface, longitudinally opposite the first surface, bearing on the first end of the housing 21 of the electric-power module 20. The heatsink 30 serves to evacuate heat generated by the electric motor 10 (shown by the arrows C1 on FIG. 2) and the heat generated by the electric-power module 20 (shown by the arrows C2 on FIG. 2) to the ambient air surrounding the motor and the electric-power module 20. The heatsink 30 also serves to evacuate the heat passively. In this sense, the heatsink 30 may be described as passive. In fact, the heat generated by the motor and the electric-power module 20 is transmitted to the heatsink 30 by thermal conduction because of the contact between the heatsink 30 and both the motor and the electric-power module 20. The heat is then evacuated by convection with the ambient air. To do that, the heatsink 30 comprises a radially outer surface 34 without any contact with a solid conducting element, in particular the stator 11 of the motor 10 and/or the housing 21 of the electric-power module 20. The radially outer surface 34 of the heatsink 30 is therefore configured to allow heat transfer with the ambient air outside the motor and the electric-power module. In that way, the heatsink 30 is distinguished from active heat exchangers which comprise a working fluid circulating in the hermetic conduit and for which the heat is evacuated by means of the working fluid. Thus, the heatsink 30 has the advantage of not needing an external mechanical element for operation thereof and advantageously does not have a risk of leaks. Such a heatsink 30 is therefore more reliable.

To improve the thermal exchanges, the heatsink may be made of a material suited for dissipating heat. Such a material advantageously has a thermal conductivity allowing the evacuation of heat. The thermal conductivity may, for example, be over 45 W·m⁻¹·K⁻¹, preferably over 100 W·m⁻¹·K⁻¹, preferably even over 200 W·m⁻¹·K⁻¹, preferably even over 400 W·m⁻¹·K⁻¹. The heatsink may be made of a metal, specifically aluminum or copper.

The heatsink 30 comprises a disk 31 which extends perpendicularly to the longitudinal axis X. The disk 31 comprises at least one first surface bearing on the first end of the stator 11 of the electric motor 10 and at least one second surface, longitudinally opposite the first surface, bearing on the first end of the housing 21 of the electric-power module 20. The first surface and the second surface of the disk 31 extend perpendicularly to the longitudinal axis X. The first surface and the second surface of the disk 31 are, in this example, shown in contact respectively with the stator 11 and the housing 21 near a periphery of the disk 31. Also, the first surface and the second surface of the disk 31 may each comprise an annular band around the longitudinal axis X which is in contact respectively with a stator 11 and the housing 21. The disk 31 of the sink, because of the circular shape thereof, allows a homogeneous evacuation of the heat around the longitudinal axis X (represented by the arrows C3 in FIG. 6). Remarkably, the disk 31 has substantially the same diameter as the circular section of the stator 11 of the motor and of the housing 21 of the electric-power module 20.

The radially outer surface 34 of the heatsink 30 here has a cylindrical shape of revolution around the longitudinal axis X.

The heatsink 30 also comprises at least one fin 32 extending radially outward from the periphery of the disk 31 or even here from the radially outer surface 34. In the example shown, the heatsink 30 comprises a plurality of fins 32 distributed uniformly around the longitudinal axis X. The fins 32 of the heatsink 30 are arranged in groups G of at least two fins 32. Here, for example, each group G comprises five fins 32. The fins 32 from each group G may be arranged circumferentially between two circumferentially consecutive electrical links. The heatsink 30 therefore comprises here six groups G of fins 32. The fins 32 serve to increase the surface for thermal exchange by convection between the disk 31 and the ambient air, thus improving the performance of the heatsink 30.

Finally, the heatsink 30 comprises an opening 33 through which the shaft 12 of the rotor extends. The opening 33 here is centered on the longitudinal axis X. The opening 33 has a circular shape.

The cooling means further comprise an annular row of blades 40 secured to the shaft 12 of the rotor. The annular row of blades 40 is arranged radially inside the housing 21. The annular row of blades 40 is shaped for driving of flow of air F over the heatsink 30 when it is rotated around the longitudinal axis X by means of the shaft 12. A radially inner end of each blade 40 may be directly connected to the shaft 12. In other words, each blade 40 may extend radially outward from the shaft 12. According to a variant, a disk (or an annular platform) may be provided mounted on the shaft 12 and on which each of the blades 40 is mounted. Alternatively, a plurality of annular blades 40 may be provided placed longitudinally one after the other inside the housing 21 where each of them is like the one described in the case of the example shown.

The airflow F blown on the heatsink 30 serves to improve the evacuation of the heat accumulated in the heatsink 30 by forced convection. The cooling of the heatsink 30 and therefore of the electric motor 10 and the electric-power module 20 is improved. Further, driving the blades 40 is implemented by the rotation of the shaft 12 of the rotor and therefore does not need additional mechanical elements. That serves to minimize the energy consumption needed to cool the electric motor 10 and the electric-power module 20, and that also serves to reduce possible sources of failure.

In order to allow passage of the airflow F to the interior of the housing 21, it comprises at least one inlet opening 24 and at least one outlet opening 25.

Each inlet opening 24 is formed through the end wall 23 in order to ensure a passage of the airflow F from outside the housing 21 towards inside the housing 21. The housing 21 here comprises four inlet openings 24, for example. The inlet openings 24 are uniformly distributed around the longitudinal axis X. Alternatively, each inlet opening 24 may be formed through the cylindrical wall 22 near the second longitudinal end of the housing 21.

Each outlet opening 25 is formed near the first end in order to ensure a passage of the airflow F from inside the housing 21 towards outside the housing 21. Each outlet opening 25 is here formed through the cylindrical wall 22 of the housing 21. The housing 21 may for example comprise six outlet openings 25. Each outlet opening 25 may be circumferentially arranged between two circumferentially consecutive output connectors 26. The outlet openings 25 may be uniformly distributed around the longitudinal axis X.

The cooling means also comprise a first cooling circuit arranged on the periphery of the stator 11 of the motor and a second cooling circuit 50 on the periphery of the housing 21 of the electric-power module 20. A cooling fluid circulates in each of the cooling circuits to produce an exchange of heat with, respectively, the stator 11 of the motor and/or the housing 21 of the electric-power module 20. As can be seen in FIG. 5, the second cooling circuit 50 is entirely formed in the cylindrical wall 22 of the housing 21. Each cooling circuit comprises at least one inlet nozzle 51 and one outlet nozzle 52 for the cooling fluid. Each cooling circuit is therefore independent. In other words, the first cooling circuit and the second cooling circuit 50 operate in parallel. Alternatively, the first cooling circuit and the second cooling circuit 50 may be in series, i.e. have a fluid connection between them. For example, the fluid may further pass through the second cooling circuit 50 and then pass through the first cooling circuit. In other words, the first cooling circuit and the second cooling circuit 50 may form a single cooling circuit.

The cooling means comprising the combination of the heatsink 30 and cooling circuits allow an increased cooling of the stator 11 of the electric motor 10 and the housing 21 of the electric-power module 20 without increasing the bulk of the propulsion unit. Further, the presence of two distinct members participating in the cooling allows a redundancy of the cooling means. In other words, cooling of the electric motor 10 or electric-power module 20 may be done even in case of failure of one of the cooling circuits or the heatsink 30.

1-8. (canceled)

9. An aircraft propulsion unit, the propulsion unit comprising:
an electrical motor (10) which comprises an annular stator (11) around a longitudinal axis (X and a rotor arranged, at least in part, radially inside the stator (11), in order to be rotated around the longitudinal axis (X);
an electric-power module (20) suited for supplying the electric motor (10) with electricity, where the electric-power module (20) comprises an annular housing (21) which extends along the longitudinal axis (X), and where the housing (21) of the electric-power module (20) comprises a first end arranged longitudinally opposite a first end of the stator (11) of the electric motor (10);
means for cooling the electric motor (10) and the electric-power module (20), where the cooling means comprise a heatsink (30) inserted longitudinally between the first end of the stator (11) of the electric motor (10) and the first end of the housing (21) of the electric-power module (20).

10. The propulsion unit according to claim 9, wherein the heatsink (30) comprises a disk (31) which extends perpendicularly to the longitudinal axis (X), where the disk (31) comprises at least one first surface bearing on the first end of the stator (11) of the electric motor (10) and at least one second surface, longitudinally opposite the first surface, bearing on the first end of the housing (21) of the electric-power module (20).

11. The propulsion unit according to claim 10, wherein the heatsink (30) comprises at least one fin (32) extending radially outward from the periphery of the disk (31).

12. The propulsion unit according to the claim 11, wherein the heatsink (30) comprises a plurality of fins (32) uniformly distributed around the longitudinal axis (X).

13. The propulsion unit according to the claim 11, wherein the fins (32) of the heatsink (30) are arranged in groups (G) of at least two fins (32).

14. The propulsion unit according to claim 9, wherein the rotor comprises a shaft (12) extending along the longitudinal axis (X), where the shaft (12) continues radially inside the housing (21) of the electric-power module (20), and where the heatsink (30) comprises an opening (33) through which the shaft (12) of the rotor extends.

15. The propulsion unit according to claim 14, wherein the cooling means comprises at least one annular row of blades (40) secured to the shaft (12) of the rotor, where the annular row of blades (40) is arranged radially inside the housing (21), and where the annular row of blades (40) is adapted for propelling an airflow (F) over the heatsink (30) when it is rotated around the longitudinal axis (X) by means of the shaft (12).

16. The propulsion unit according to claim 15, wherein the housing (21) comprises an end wall (23) which extends transversely to the longitudinal axis (X) near a second end of the housing (21) in the longitudinal direction, where the housing (21) comprises at least one inlet opening (24) formed through the end wall (23) to provide a passage for the airflow (F) from the outside of the housing (21) to the inside of the housing (22).

17. The propulsion unit according to claim 16, wherein the end wall (23) extends perpendicularly to the longitudinal axis (X).

18. The propulsion unit according to claim 16, wherein the housing (21) comprises at least one outlet opening (25) near the first end to provide a passage for the airflow (F) from inside the housing (21) to outside the housing (21).

19. The propulsion unit according to claim 9, wherein the cooling means comprises at least one cooling circuit (50) arranged on the periphery of the stator (11) of the motor (10) and/or on the periphery of the housing (21) of the electric-power module (20) and wherein a cooling fluid circulates to produce an exchange of heat with, as applicable, the stator (11) of the motor (10) and/or the housing (21) of the electric-power module (20).
